(19) United States
(12) Patent Application Publication
(10) Pub. No.: US 2012/0320266 A1
(43) Pub. Date: Dec. 20, 2012

(54) TRANSMISSION APPARATUS, RECEPTION APPARATUS, BROADCAST SYSTEM, TRANSMISSION METHOD, RECEPTION METHOD, AND PROGRAM THEREFOR

(75) Inventors: Yoshiharu Dewa, Tokyo (JP); Naohisa Kitazato, Tokyo (JP)

(73) Assignee: SONY CORPORATION, Tokyo (JP)

(21) Appl. No.: 13/492,239

(22) Filed: Jun. 8, 2012

(30) Foreign Application Priority Data
Jun. 17, 2011 (JP) 2011-134938

(51) Int. Cl. H04N 7/088

(52) U.S. Cl. 348/468; 348/E07.033

(57) ABSTRACT

A transmission apparatus including a generation unit and a transmission unit. The generation unit is configured to generate, in broadcast data, in association with a delivery data body, posting time information of the delivery data body, and identification information for identifying a delivery subject of the delivery data body, delivery data including the delivery data body, the posting time information, and the identification information. The transmission unit is configured to transmit the broadcast data including the generated delivery data such that, based on the identification information of the delivery data, a reception apparatus can receive the delivery data body corresponding to the identification information.

### BACKGROUND

The present disclosure relates to a transmission apparatus that transmits information using broadcast waves, a reception apparatus that receives the information, a broadcast system including those apparatuses, transmission and reception methods therefor, and a program therefor.

In television broadcasts and radio broadcasts, a program is organized for each broadcast station, and a content thereof is transmitted in a time series.

In a teletext broadcast system disclosed in Japanese Patent Application Laid-open No. Hei 7-264560 (hereinafter, referred to as Patent Document 1), for example, a teletext broadcast is performed, and a broadcast station for such a broadcast has an ID for identifying a viewer as a transmission destination. The viewer requests, using a phone line, a program that he/she wishes to view. As a result, the broadcast station adds an ID of the viewer to the requested program, converts the program and ID into television signals, and transmits them. A reception apparatus of the viewer storing the ID receives the television signals of the broadcast program and stores a content of the program when the ID that is included in the signals and has been set with the program matches the ID stored therein (see, e.g., paragraphs [0008] to [0010] in specification of Patent Document 1, and FIG. 3).

Incidentally, in the case of a broadcast system in which there are a plurality of viewers with respect to one broadcast station, a content of a broadcast program is assumed to be one that is desired by the greatest number of viewers. Therefore, the content of the broadcast program does not necessarily match information that individual viewers wish to view or obtain.

On the other hand, various services on the Internet enable users to individually select and obtain information.

### SUMMARY

It is desirable for individual users to selectively obtain desired information using a broadcast as a solid broadcast infrastructure.

In view of the circumstances as described above, there is a need for a technique of a broadcast system that enables individual users to selectively obtain desired information.

According to an embodiment of the present disclosure, there is provided a transmission apparatus including a generation unit and a transmission unit.

The generation unit is configured to generate, in broadcast data, in association with a delivery data body, posting time information of the delivery data body, and identification information for identifying a delivery subject of the delivery data body, delivery data including the delivery data body, the posting time information, and the identification information.

The transmission unit is configured to transmit the broadcast data including the generated delivery data such that, based on the identification information of the delivery data, a reception apparatus can receive the delivery data body corresponding to the identification information.

In this embodiment, the generation unit generates, in the broadcast data, the delivery data including the delivery data body, the posting time information, and the identification information, and the transmission unit transmits the broadcast data. Since the reception apparatus receives the delivery data in the broadcast data by broadcast based on the identification information, the individual users of the reception apparatus can selectively obtain desired information. Further, the reception apparatus is capable of presenting the user with the information in a time series based on the posting time information.

The generation unit may generate the delivery data in subtitle data out of the broadcast data. In general, in a digital television broadcast, the subtitle data is in sync with audio data and video data and transmitted in a time series. By generating the delivery data in the subtitle data, the embodiment of the present disclosure can be realized immediately at low costs without largely changing the existing broadcast infrastructure.

In particular, the generation unit may generate the delivery data in at least one of a subtitle management data packet and a subtitle sentence data packet in the subtitle data.

The generation unit may additionally generate, in the broadcast data, one service name information item associated with a plurality of different identification information items. With this structure, for example, the transmission apparatus of one broadcast station corresponding to the one service name information item can transmit programs respectively corresponding to a plurality of identification information items so that the user can select those programs.

The generation unit may additionally generate, in the broadcast data, information indicating which of official identification information and unofficial identification information the identification information is. With this structure, the user can grasp which of official information and unofficial information the delivery data is.

The transmission apparatus may further include an extraction unit and a conversion unit. The extraction unit is configured to extract, from a server capable of storing a posting data body, posting time information of the posting data body, and identification information for identifying a posting subject of the posting data body in association with one another, the posting data body, the posting time information, and the identification information of the posting subject. The conversion unit is configured to convert the posting data body, the posting time information, and the identification information of the posting subject that have been extracted into the delivery data body, the posting time information, and the identification information. The transmission apparatus can transmit, in cooperation with such a microblog server, the delivery data body by broadcast.

According to an embodiment of the present disclosure, there is provided a reception apparatus including a reception unit and a presentation information generation unit.

The reception unit is capable of receiving delivery data that is included in broadcast data transmitted from a transmission apparatus by broadcast, the delivery data including a delivery data body, posting time information of the delivery data body, and identification information for identifying a delivery subject of the delivery data body that are associated with one another.

The presentation information generation unit is configured to generate, based on the received identification information of the delivery data, information for presenting the delivery data body corresponding to the identification information in a time series based on the posting time information.

Since the reception apparatus presents the user thereof with the delivery data body based on the received identification information in a time series based on the posting time information, the user can selectively obtain desired information in a time series.

The reception apparatus may further include a setting unit configured to prompt a user of the reception apparatus to select at least one identification information item out of a plurality of different identification information items and set the identification information. In this case, the presentation information generation unit judges whether the identification information of the delivery data received by the reception unit matches the identification information set by the setting unit and generates, when the identification information items match, information for presenting the delivery data body corresponding to the identification information. With this structure, the user can selectively obtain desired information.

The setting unit may generate a screen on which at least one delivery subject can be selected out of a plurality of delivery subjects corresponding to the plurality of identification information items. In this case, the presentation information generation unit generates image information of the delivery subject corresponding to the at least one identification information item selected by the user. With this structure, the user can select one delivery subject while looking at a selection screen displayed on a display unit.

The presentation information generation unit may generate audio information of the delivery data body corresponding to the at least one identification information item selected by the user. With this structure, the user can obtain desired information even when the user is visually impaired.

According to an embodiment of the present disclosure, there is provided a broadcast system including a transmission apparatus and a reception apparatus.

The transmission apparatus includes a generation unit configured to generate, in broadcast data, in association with a delivery data body, posting time information of the delivery data body, and identification information for identifying a delivery subject of the delivery data body, delivery data including the delivery data body, the posting time information, and the identification information, and a transmission unit configured to transmit the broadcast data including the generated delivery data.

The reception apparatus includes a reception unit capable of receiving the delivery data included in the transmitted broadcast data, and a presentation information generation unit configured to generate, based on the received identification information of the delivery data, information for presenting the delivery data body corresponding to the identification information in a time series based on the posting time information.

According to an embodiment of the present disclosure, there is provided a transmission method for a transmission apparatus including generating, in broadcast data, in association with a delivery data body, posting time information of the delivery data body, and identification information for identifying a delivery subject of the delivery data body, delivery data including the delivery data body, the posting time information, and the identification information.

The broadcast data including the generated delivery data is transmitted such that, based on the identification information of the delivery data, a reception apparatus can receive the delivery data body corresponding to the identification information.

According to an embodiment of the present disclosure, there is provided a reception method for a reception apparatus including receiving delivery data that is included in broadcast data transmitted from a transmission apparatus by broadcast, the delivery data including a delivery data body, posting time information of the delivery data body, and identification information for identifying a delivery subject of the delivery data body that are associated with one another.

Based on the received identification information of the delivery data, information for presenting the delivery data body corresponding to the identification information in a time series based on the posting time information is generated.

A program according to an embodiment of the present disclosure is a program that causes a computer (transmission apparatus) to execute the transmission method described above.

A program according to an embodiment of the present disclosure is a program that causes a computer (reception apparatus) to execute the reception method described above.

As described above, according to the embodiments of the present disclosure, individual users can selectively obtain desired information.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a structure of a broadcast system according to a first embodiment of the present disclosure;

FIG. 2 is a diagram showing a content of a subtitle data packet;

FIG. 3 is a diagram for explaining a subtitle transmission and display thereof;

FIG. 4 is a diagram showing a definition of data units included in each of a subtitle management data packet and a subtitle sentence data packet;

FIG. 5 is a table showing data unit types;

FIG. 6 is a diagram showing a data ID list;

FIG. 7 is a diagram showing delivery data;

FIG. 8 is a flowchart showing processing carried out when delivery data of broadcast data transmitted from a transmission apparatus is received by a reception apparatus for the first time;

FIG. 9 is a flowchart showing processing of the reception apparatus for presenting a delivery data body;

FIG. 10A is a diagram showing information respectively corresponding to service names and information respectively corresponding to data IDs, that have been displayed in Step 108, and FIG. 10B is a diagram showing an example of a screen of the reception apparatus displaying the delivery data body;

FIG. 11 are diagrams showing a reception apparatus according to another embodiment of the present disclosure; and

FIG. 12 is a diagram showing a broadcast system according to a second embodiment of the present disclosure.

### DETAILED DESCRIPTION OF EMBODIMENTS

Hereinafter, embodiments of the present disclosure will be described with reference to the drawings.

### First Embodiment

### Structure of Broadcast System

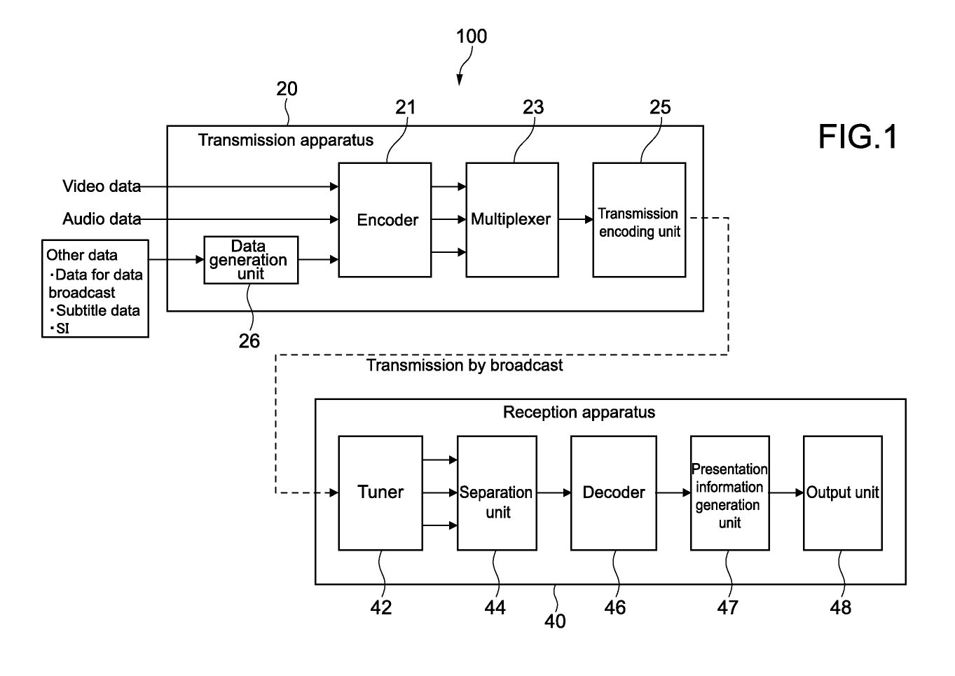

FIG. 1 is a block diagram showing a structure of a broadcast system according to a first embodiment of the present disclosure.

The broadcast system 100 includes a transmission apparatus 20 and a reception apparatus 40. The transmission apparatus 20 is typically an apparatus that a television broadcast station owns. The reception apparatus 40 is an apparatus that receives data transmitted from the transmission apparatus 20 by broadcast. Both the transmission apparatus 20 and the reception apparatus 40 include computer elements, that is, basic hardware such as a CPU, a RAM, and a ROM.

The transmission apparatus 20 includes an encoder 21, a multiplexer 23, a transmission encoding unit 25, and a data generation unit (generation unit) 26.

The encoder 21 compression-codes video data, audio data, and other types of data. MPEG (Moving Picture Experts Group) 2 is typically used as a codec, but other codecs may be used instead. Other types of data are, for example, data for a data broadcast and subtitle data.

The multiplexer 23 multiplexes video data, audio data, and other types of data. For example, the multiplexer 23 packages ESs (Elementary Streams) of videos, audios, and the like to generate PESs (Packetized Elementary Streams), synthesizes the PESs, and generates a TS (Transport Stream) as a part or all of broadcast data.

The transmission encoding unit 25 modulates the multiplexed TS by any of various modulation methods such as QPSK (Quadrature Phase Shift Keying), BPSK (Binary Phase Shift Keying), and OFDM (Orthogonal Frequency Division Multiplex). The TS may be modulated by other modulation methods instead of the modulation methods described above. The data modulated by the transmission encoding unit 25 is transmitted by broadcast. In this case, mainly a CPU of the transmission apparatus 20 functions as a transmission unit.

The data generation unit 26 generates, in subtitle data, a data ID list and delivery data to be described later.

It should be noted that the encoder 21, the multiplexer 23, the transmission encoding unit 25, and the data generation unit 26 are constituted of different apparatuses that are mutually connected either wirelessly or by wires. Further, the apparatuses may be geographically located at different places. When the apparatuses are constituted of different apparatuses, the apparatuses each include a transmission unit that transmits various types of data.

Typically, equipment that carries out modulation processing by the transmission encoding unit 25 and transmits modulated data by broadcast is located at a place geographically apart from a television broadcast station.

The reception apparatus 40 includes a tuner 42, a separation unit 44, a decoder 46, a presentation information generation unit 47, and an output unit 48.

The tuner 42 selects one service (channel) from data transmitted from each broadcast station and demodulates data of the selected service. The demodulation processing is processing for demodulating data that has been modulated for transmission by the transmission encoding unit 25.

The separation unit 44 separates video, audio, and other data out of the multiplexed TS.

The decoder 46 decodes data that has been encoded (compression coding) by the codec of the encoder 21.

As will be described later, the presentation information generation unit 47 extracts a data ID list from subtitle data included in the broadcast data and generates, for selection setting of a service name or the like by a user, information for presenting the service name or the like to the user. The presentation information generation unit 47 also extracts at least a delivery data body from the subtitle data and generates information for presenting the delivery data body to the user.

The output unit 48 includes a display unit and a speaker.

With such a structure of the reception apparatus 40, videos and audios broadcasted from the television broadcast station can be presented to the user of the reception apparatus 40.

It should be noted that the tuner 42, the separation unit 44, the decoder 46, and the output unit 48 may be constituted of different apparatuses that are connected either wirelessly or by wires.

### (Subtitle Data)

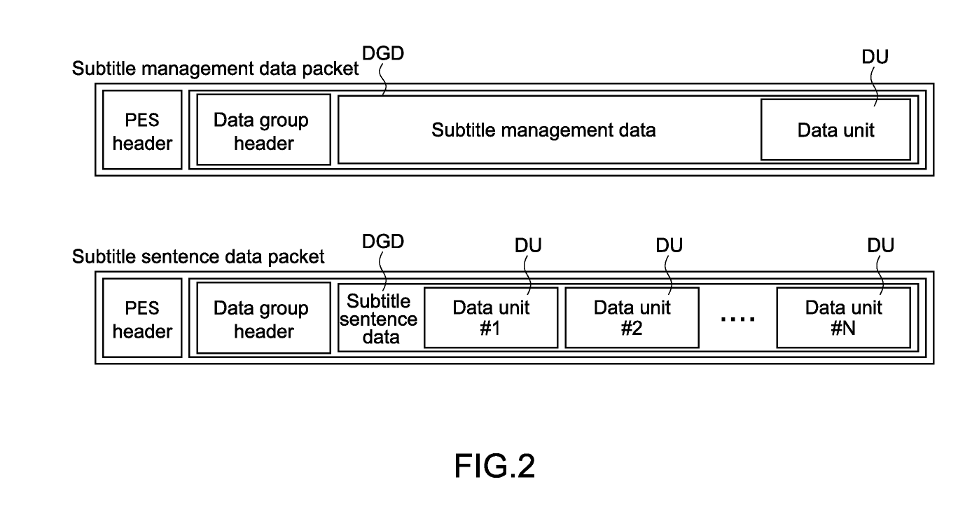

FIG. 2 is a diagram showing a content of a subtitle data packet.

The subtitle data packet is generally formed as a PES packet. It should be noted that a data source of the subtitle PES packet is a subtitle ES. The subtitle PES packet is constituted of two types of packets, that is, a subtitle management data packet and a subtitle sentence data packet.

The subtitle management data packet includes data group data (DGD) and subtitle management data. Although not shown, the subtitle management data includes a subtitle language type, a transmission mode, a time control mode, the number of languages, a display mode, a data unit loop length, and one or a plurality of data units (DUs).

The subtitle sentence data packet includes subtitle sentence data as the data group data (DGD). The subtitle sentence data includes a time control mode, a time stamp, a data unit loop length, and one or a plurality of data units (DUs).

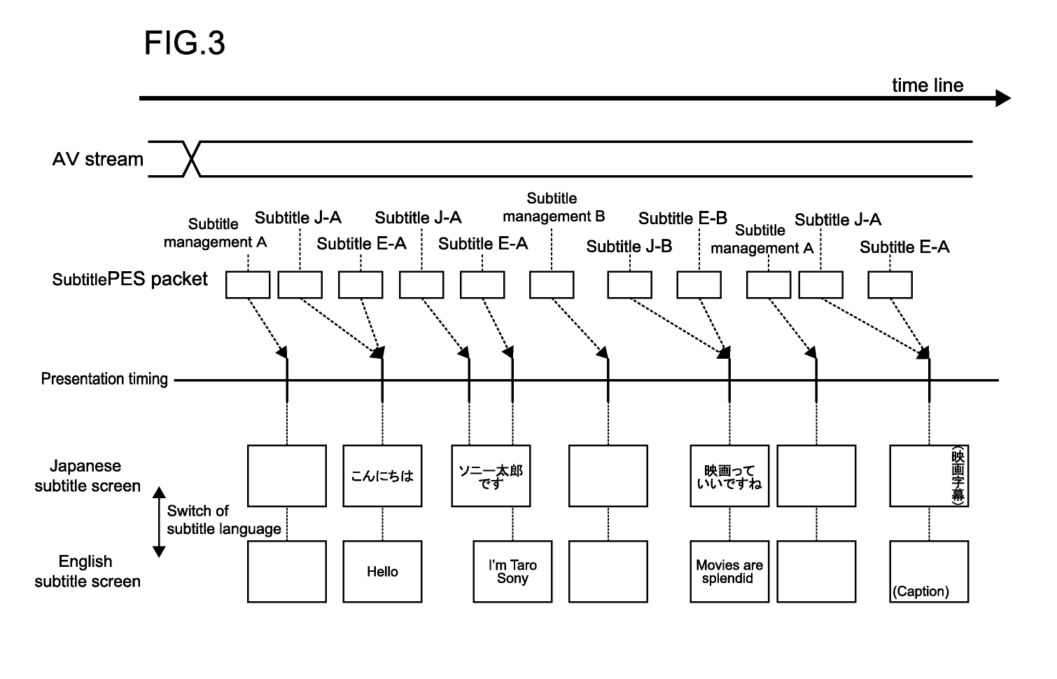

FIG. 3 is a diagram for explaining a subtitle transmission and display thereof.

In FIG. 3, a direction from left to right is a time elapse direction. The reception apparatus 40 receives broadcast data and receives, via the tuner 42 and the separation unit 44 as described above, an AV stream (audio and video data stream) of one service (channel) and a subtitle PES packet in a time series. The reception apparatus 40 also receives data for a data broadcast.

In FIG. 3, by a management of a subtitle management data packet A, for example, a subtitle sentence data packet J (Japanese) A and a subtitle sentence data packet E (English) A are presented on a screen at predetermined presentation timings. Further, by a management of a subtitle management data packet B, for example, a subtitle sentence data packet J (Japanese) B and a subtitle sentence data packet E (English) B are presented on the screen at predetermined presentation timings.

Japanese and English are switched by a predetermined input operation of the user to the reception apparatus 40. When the reception apparatus 40 is, for example, a television, Japanese and English are switched by an operation to a remote controller of the television, for example.

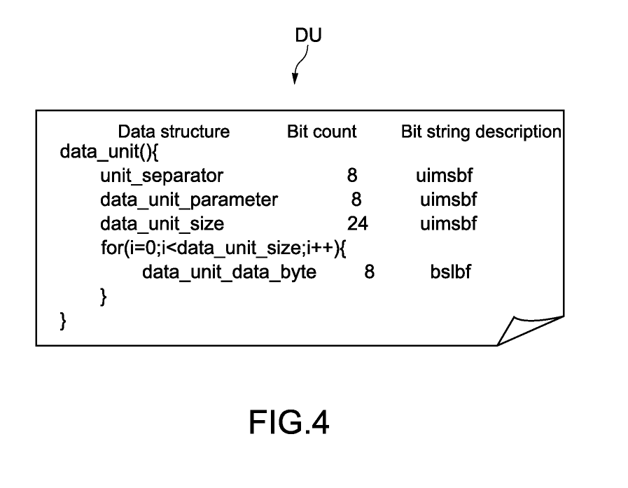

FIG. 4 is a diagram showing a definition of a data unit included in each of the subtitle management data packet and the subtitle sentence data packet.

“unit_separator” indicates a start of a data unit.

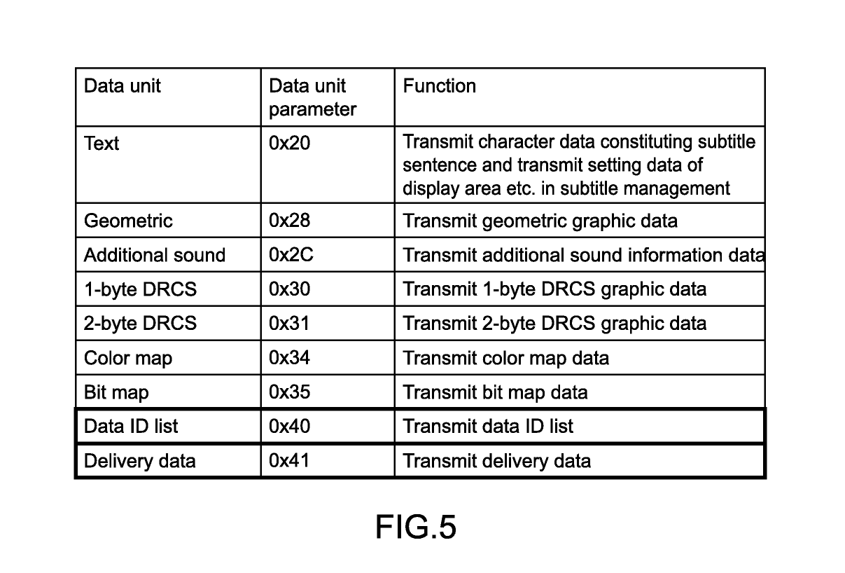

“data_unit_parameter” indicates a type of data in the data unit. For example, “0x20” indicates that the data unit is a “text” of a subtitle (see FIG. 5).

“data_unit_size” indicates a size of the data unit.

FIG. 5 is a table showing data unit types.

The feature of the present disclosure is that the data unit type defined by “data_unit_parameter” is extended. As a characteristic data unit of the present disclosure, a data ID list and delivery data are defined. “data_unit_parameter” of the data ID list and delivery data are defined as, for example, “0x40” and 0x41″, respectively.

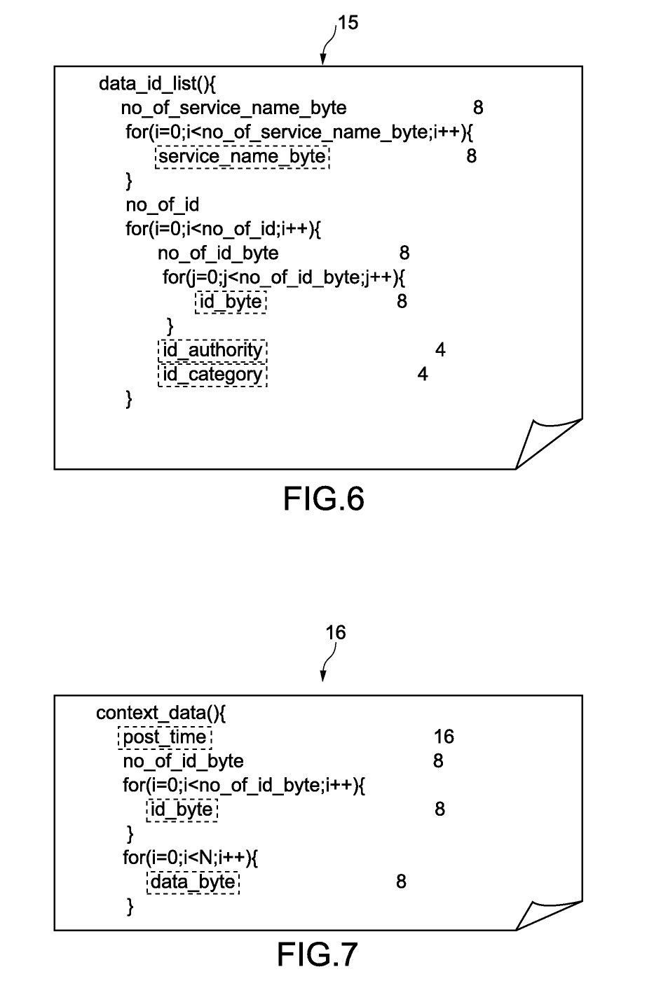

FIG. 6 is a diagram showing a data ID list.

“service_name_byte” indicates a service name (channel name).

“id_byte” is a data ID and identification information for identifying a delivery subject. The data ID is something like an ID of one program that one service (channel) provides. The service name is a generic name of a plurality of different data IDs. Further, the delivery subject is something like (a subject of) a program.

“id_authority” is information that indicates whether the data ID is official or not.

“id_category” is information that indicates a category of the data ID. The category used herein refers to a news report, education, a variety program, a documentary, sports, and so on.

FIG. 7 is a diagram showing delivery data.

“post_time” is posting time information of a delivery data body.

“id_byte” is the data ID as described above.

“data_byte” is information on the delivery data body.

The posting time is largely defined in two forms as described below.

1. A time at which an operator on a broadcast station side (e.g., person having some kind of a business relation with that broadcast station; hereinafter, referred to as operator or the like) stores content information of a delivery data body (i.e., information on delivery data body) in a transmission-side apparatus. The transmission-side apparatus is an apparatus directly connected to the transmission apparatus 20 or indirectly connected thereto via a network.

2. A time at which the operator or the like on the broadcast station side performs, after storing the content information of the delivery data body, a predetermined input operation with respect to the transmission-side apparatus for posting the content information of the delivery data body. The predetermined input operation typically refers to an operation of pressing a posting button (GUI or actual button) provided in the transmission-side apparatus.

In addition to 1 and 2 above, a posting time similar to those times are the posting time of the present disclosure.

As described above, in the present disclosure, a data ID list 15 and delivery data 16 each including a data ID are defined as the data unit. In other words, at least the delivery data body, the posting time information, and the data ID are associated with one another. Such an association is made by the data generation unit 26.

Typically, the data ID list 15 is generated as a data unit of a subtitle management data packet, and the delivery data 16 is generated as a data unit of a subtitle sentence data packet, though they may be opposite. Alternatively, both the data ID list 15 and the delivery data 16 may be generated as one of the data unit of a subtitle management data packet and the data unit of a subtitle sentence data packet.

### (Processing of Reception Apparatus)

Hereinafter, processing of the reception apparatus will be described. The processing of the reception apparatus 40 is realized in cooperation with a software program stored in a storage device of the reception apparatus 40 and a hardware resource such as a CPU. Hereinafter, for convenience, a subject of the processing will mainly be the CPU.

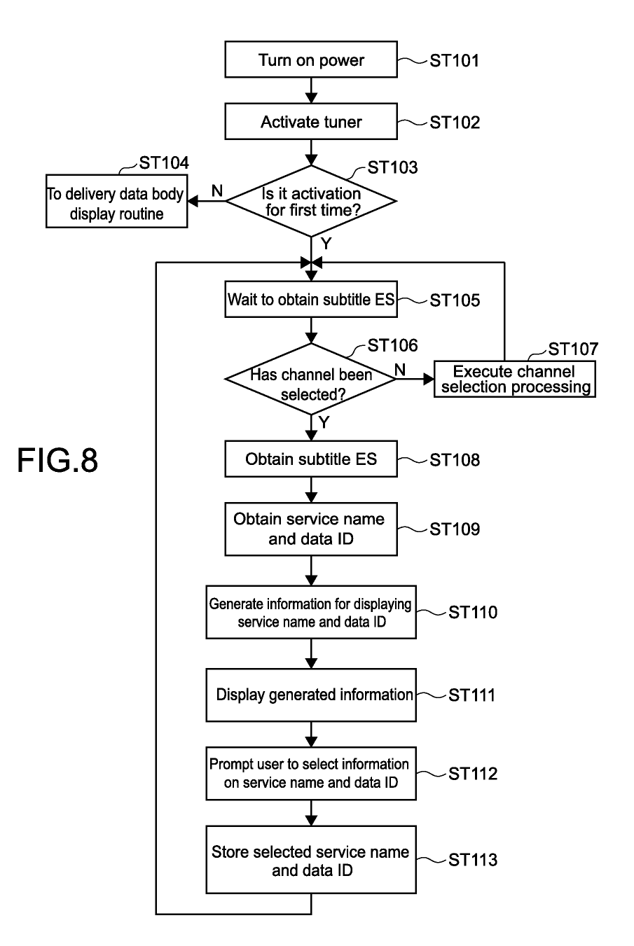

FIG. 8 is a flowchart showing processing carried out when broadcast data transmitted from the transmission apparatus 20 is received by the reception apparatus 40 for the first time.

Power of the reception apparatus 40 is turned on by the user (Step 101). The tuner 42 is activated (Step 102), and a judgment is made on whether the activation is a first activation (Step 103). When judged NO in Step 103, the CPU executes a routine for displaying mainly a delivery data body out of the delivery data 16 (Step 104).

When judged YES in Step 103, the CPU is put to a standby state for obtaining a subtitle ES (Step 105) and judges whether one channel has been selected by an input operation of the user (Step 106).

When one channel has been selected, the CPU obtains a subtitle ES in broadcast data transmitted by that channel (Step 108). In this case, the CPU functions as a reception unit.

The CPU and the presentation information generation unit 47 obtain, from the subtitle ES, information on a service name and data ID (Step 109) to generate information corresponding to the service name and information on a delivery subject corresponding to the data ID (Step 110). Then, the CPU displays (presents) those information items on the screen (Step 111).

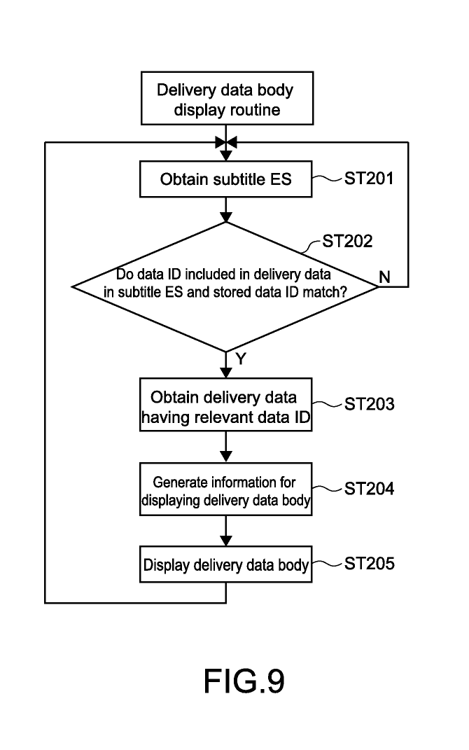

The processing for presenting the delivery data body (Step 104) will be described later with reference to FIG. 9.

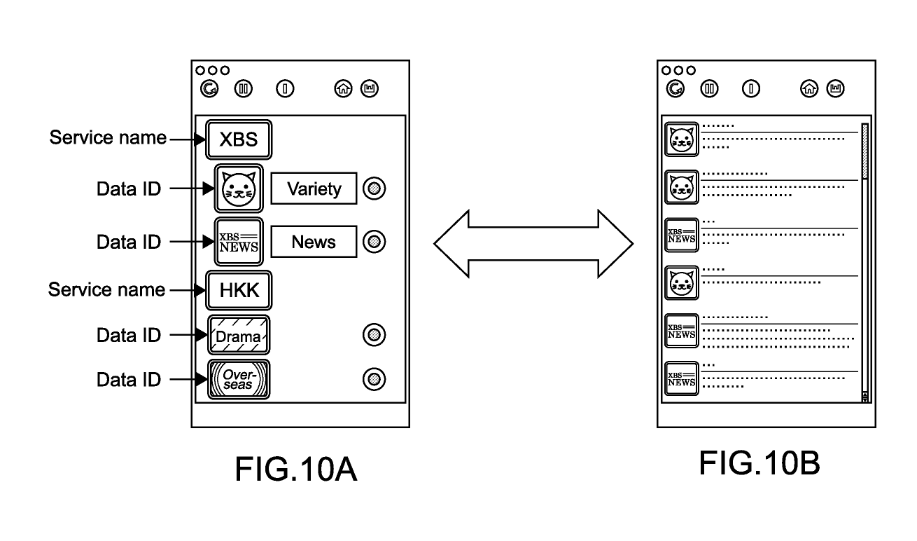

FIG. 10A shows an example of a case where, when the reception apparatus 40 is a portable apparatus such as a cellular phone, the information corresponding to the service name and the information corresponding to the data ID, that have been displayed in Step 111, are displayed as GUIs (Graphical User Interfaces).

Further, FIG. 10A shows a case where the CPU carries out the processing shown in FIG. 8 two or more times, and two or more different channels are selected by the user. Moreover, in this example, information items corresponding to “id_category” of a variety program and news are also displayed.

It should be noted that, as described above, the information items respectively corresponding to the service name and data ID may be displayed as text data instead of an image.

When data items of “id_authority” and “id_category” are not generated in the subtitle ES, information items thereof do not need to be displayed.

The reception apparatus 40 may include a program with which, by a user command, setting of a data display method or setting of whether to display data can be customized.

After displaying the information items respectively corresponding to the service name and data ID, the CPU sets the service name and data ID in Steps 112 and 113. In this case, the CPU functions as a setting unit. For example, the user selects and determines at least one of the displayed information items respectively corresponding to the service name and data ID by an input operation to the reception apparatus 40 (Step 112). After that, the CPU of the reception apparatus 40 stores the selected data ID in the storage device of the reception apparatus 40 (Step 113).

As described above, by displaying a screen on which the user can select one delivery subject out of a plurality of delivery subjects corresponding to a plurality of data IDs, the user can select one delivery subject (program, data ID) while looking at the selection screen displayed on the display unit.

The CPU of the reception apparatus 40 may set (store) either the service name or the data ID. When the service name is stored, data IDs (programs) delivered by that service name may all be stored.

By using a nonvolatile device as the storage device storing the data ID, the CPU can execute the processing shown in FIG. 9 to be described below using information stored in the storage device even after power is turned off.

Next, referring to FIG. 9, the routine for displaying the delivery data body will be described. In this processing, an example of displaying delivery data bodies corresponding to a plurality of different data IDs of one service name will be described.

The CPU of the reception apparatus 40 obtains a subtitle ES (Step 201). The CPU judges whether a data ID included in the delivery data 16 of the subtitle ES matches the data ID stored in Step 110 (Step 202).

When judged YES in Step 202, the CPU and the presentation information generation unit 47 obtain the delivery data 16 that has the matched data ID (Step 203) to generate information for presenting mainly a delivery data body of the delivery data 16 on the display unit (Step 204). Then, the CPU displays the delivery data body (Step 205). In this case, the CPU typically generates and displays screen information for displaying the delivery data body in a time series based on posting time information of the delivery data 16 out of the delivery data 16.

The delivery data 16 included in the subtitle PES packets transmitted at predetermined time intervals has posting time information that is in sync with each of the subtitle PES packets. Therefore, the reception apparatus 40 can display the delivery data body in a time series based on the posting time information.

FIG. 10B shows an example of the screen of the reception apparatus 40 displaying the delivery data body.

The format of the delivery data body is basically a text. However, the format of the delivery data body may be a still image, a moving image, music, or link information (URL etc.) thereof. A data amount of the delivery data body may be limited. In the example shown in FIG. 10B, the delivery data bodies corresponding to the plurality of data IDs are displayed in a time series in a longitudinal direction on the screen.

The display method is not particularly limited, and delivery data bodies corresponding to one or more data IDs of one service name may be displayed in a time series, for example. Alternatively, delivery data bodies corresponding to data IDs included in a plurality of service names may be displayed in a time series. The reception apparatus 40 may include a customize function for selecting the display method.

As described above, according to the present disclosure, the transmission apparatus 20 generates, in the broadcast data, the delivery data 16 including the delivery data body, the posting time information, and the data ID and transmits the broadcast data. Since the reception apparatus receives the delivery data 16 in the broadcast data by broadcast based on the data ID, individual users of the reception apparatus 40 can selectively obtain desired information. The user can also obtain those information items in a time series.

In general, in a digital television broadcast (may be ARIB (Association of Radio Industries and Business) system or DVB (Digital Video Broadcasting) system), subtitle data is transmitted in sync with audio data and video data in a time series. By generating the delivery data 16 in the subtitle data, the present disclosure can be realized immediately at low costs without largely changing an existing broadcast infrastructure.

According to the present disclosure, information can be stably delivered even in an area where the infrastructure is fragile, such as a disaster area. For example, in a current television broadcast, the user can only obtain information on an announcement by the government, national news, and the like at the time of disaster. Also at the time of disaster, although local governments can individually use audio notifications such as a speaker, there is no guarantee that they will operate depending on a setting condition of the infrastructure at that time. However, according to the present disclosure, the users can individually obtain local information on local governments, information on local evacuation areas, and the like.

According to the present disclosure, individual users can selectively obtain desired information from mass-targeted broadcast data.

According to the present disclosure, since the delivery subject can designate which of an official data ID and an unofficial data ID the data ID is, the user can grasp which of official information and unofficial information the information on the delivery data body is. As a result, incorrect information and the like can be eliminated, for example.

According to the present disclosure, since the delivery data 16 is transmitted by broadcast, it becomes difficult to fabricate the delivery data 16.

### (Another Embodiment 1 of Reception Apparatus)

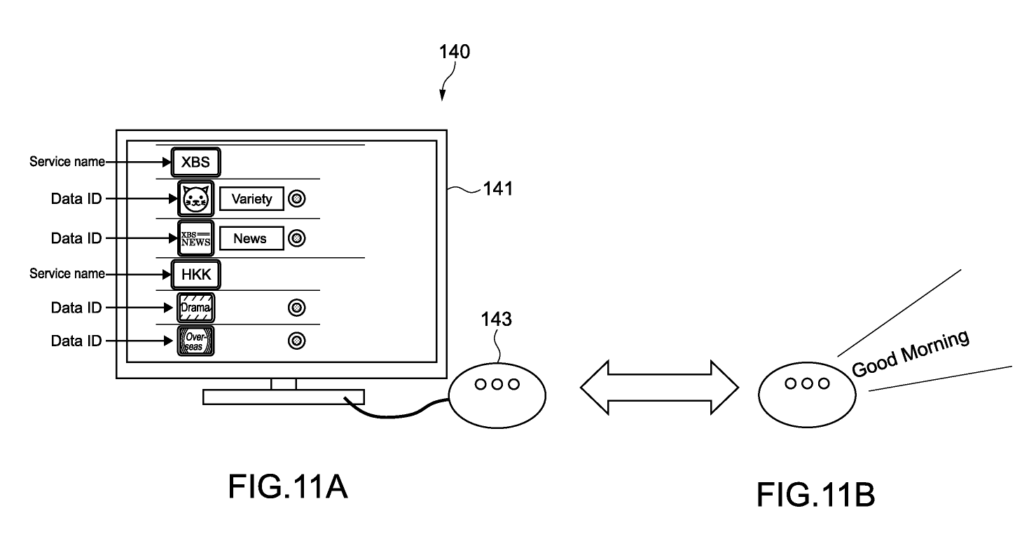

FIGS. 11A and 11B are diagrams showing a reception apparatus according to another embodiment of the present disclosure. In descriptions below, descriptions on elements, functions, and the like that are the same as those of the broadcast system 100 according to the embodiment above will be simplified or omitted, and different points will mainly be described.

As shown in FIG. 11A, a reception apparatus 140 includes a television 141 and a (remote) controller 143 connected to the television 141 by wires (or wirelessly). The controller 143 is an apparatus to which the user is capable of performing an input operation and has a built-in speaker. A screen displayed on the television 141 is, similar to the screen displayed on the reception apparatus 40, a screen showing image information corresponding to each service name and data ID. For example, similar to the processing shown in FIG. 8, the user performs a selection operation for a service name and data ID via the controller 143.

In FIG. 11B, the controller 143 executes the processing shown in FIG. 9 by voice instead of “display” using its own speaker. In other words, a CPU of the controller 143 (or television 141) generates as audio information, based on a stored data ID and posting time information, information on a delivery data body corresponding to the data ID in a time series and presents it to the user. In this case, in presenting the delivery data body to the user, the CPU may also generate posting time information in the information on the delivery data body and also present the posting time as the audio information.

As a result, even when the user is visually impaired, for example, the user can obtain desired information.

In the example shown in FIGS. 11A and 11B, the portable apparatus shown in FIGS. 10A and 10B may be used instead of the television 141. Further, the reception apparatus may be an apparatus that does not have a display unit and executes the setting processing by the user, that is shown in FIG. 8, by audio recognition processing.

### (Another Embodiment 2 of Reception Apparatus)

Another embodiment of the reception apparatus will be described. Although not shown, the reception apparatus includes a plurality of tuners, for example. With this structure, in the delivery data body presentation processing (see FIG. 9), the reception apparatus can present, in a time series, delivery data bodies corresponding to a plurality of data IDs in a plurality of services names.

### Second Embodiment

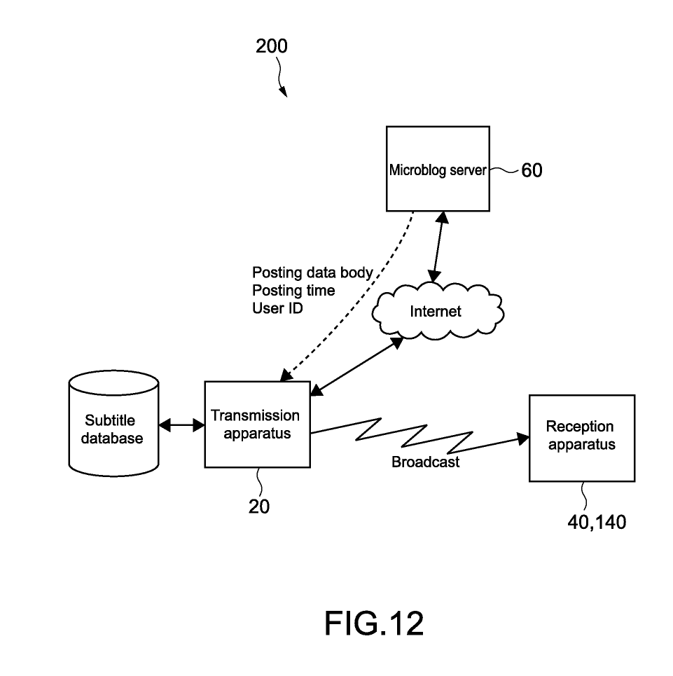

FIG. 12 is a diagram showing a broadcast system according to a second embodiment of the present disclosure.

A broadcast system 200 includes the transmission apparatus 20, a microblog server 60, and the reception apparatus 40 (or 140). At least the transmission apparatus 20 and the microblog server 60 are connected to a network such as the Internet. The microblog server 60 (hereinafter, simply referred to as server) has a computer function and is typically a twitter server. A communication form from the transmission apparatus 20 to the reception apparatus 40 is by broadcast as in the embodiment above.

The server 60 stores a posting data body of a user of the server 60, that is, a user of the microblog, posting time information of the posting data body, and identification information (user ID) of a posting subject (microblog user) of the posting data body in association with one another. The posting data body is text information posted by the microblog user and other types of information.

Hereinafter, processing of the transmission apparatus 20 in the broadcast system 200 will be described.

The transmission apparatus 20 extracts the posting data body, the posting time information, and the user ID from the server 60. The transmission apparatus 20 converts the posting data body, the posting time information, and the user ID that have been extracted from the server 60 into a delivery data body, posting time information, and data ID. In other words, the transmission apparatus 20 generates a content of the data extracted from the server 60 in the data ID list 15 and the delivery data 16. In this case, mainly the CPU of the transmission apparatus 20 functions as a conversion unit.

As a result, the transmission apparatus 20 can transmit, by broadcast in a time series, the posting data body posted in the server 60 by the processing of FIGS. 8 and 9. Further, the reception apparatus 40 can receive the posting data and present information on the posting data to the user of the reception apparatus 40 in a time series.

As described above, the transmission apparatus 20 can automatically present the information stored in the server 60 to the user of the reception apparatus 40 in cooperation with the microblog server 60.

This embodiment is particularly effective when, for example, the microblog user and a delivery subject corresponding to the service name or data ID in the present disclosure are the same, that is, the microblog user is an operator on the broadcast station side. For example, when the server 60 is a twitter server, the transmission apparatus 20 can automatically transmit, by broadcast, data of a body (tweet) posted by a predetermined program subject of a broadcast station that owns the transmission apparatus 20.

### Other Embodiments

The present disclosure is not limited to the embodiments above, and various other embodiments can also be realized.

The reception apparatus 40 (or 140) of the embodiment above has been an apparatus capable of displaying an AV stream. However, the reception apparatus 40 is not limited thereto and may be an apparatus that mainly aims at presenting the delivery data 16 (and data ID list 15). Alternatively, the reception apparatus 40 may be an apparatus that is incapable of displaying video data and presents (by display or audio output) the delivery data 16 (and data ID list 15).

Alternatively, the reception apparatus 40 may be an apparatus that executes processing up to generation of information for presenting a delivery data body. The generated information may be presented (by display or audio output) by another apparatus connected to the reception apparatus 40 by wires or wirelessly.

The reception apparatus 40 is not limited to the television, cellular phone, and the like described above and may be a desktop PC, a laptop PC, a radio apparatus, or the like.

Although the data ID list 15 and the delivery data 16 have been generated in subtitle data in the embodiments above, they may be generated in broadcast data excluding the subtitle data. An example of the broadcast data excluding the subtitle data is SI (Service information) such as EIT (Event Information Table) and SDT (Service Description Table. Alternatively, the broadcast data excluding the subtitle data may be at least one of data for a data broadcast, video data, and audio data.

At least two feature portions may be combined out of the feature portions of the embodiments above.

The present disclosure may also take the following structures.

(1) A transmission apparatus, including:

a generation unit configured to generate, in broadcast data, in association with a delivery data body, posting time information of the delivery data body, and identification information for identifying a delivery subject of the delivery data body, delivery data including the delivery data body, the posting time information, and the identification information; and

a transmission unit configured to transmit the broadcast data including the generated delivery data such that, based on the identification information of the delivery data, a reception apparatus can receive the delivery data body corresponding to the identification information.

(2) The transmission apparatus according to (1),

in which the generation unit generates the delivery data in subtitle data out of the broadcast data.

(3) The transmission apparatus according to (2),

in which the generation unit generates the delivery data in at least one of a subtitle management data packet and a subtitle sentence data packet in the subtitle data.

(4) The transmission apparatus according to any one of (1) to (3),

in which the generation unit additionally generates, in the broadcast data, one service name information item associated with a plurality of different identification information items.

(5) The transmission apparatus according to any one of (1) to (4),

in which the generation unit additionally generates, in the broadcast data, information indicating which of official identification information and unofficial identification information the identification information is.

(6) The transmission apparatus according to any one of (1) to (5), further including:

an extraction unit configured to extract, from a server capable of storing a posting data body, posting time information of the posting data body, and identification information for identifying a posting subject of the posting data body in association with one another, the posting data body, the posting time information, and the identification information of the posting subject; and

a conversion unit configured to convert the posting data body, the posting time information, and the identification information of the posting subject that have been extracted into the delivery data body, the posting time information, and the identification information.

(7) A reception apparatus, including:

a reception unit capable of receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and

a presentation information generation unit configured to generate, based on the received identification information of the delivery data, information for presenting the delivery data body corresponding to the identification information in a time series based on the posting time information.

(8) The reception apparatus according to (7), further including

a setting unit configured to prompt a user of the reception apparatus to select at least one identification information item out of a plurality of different identification information items and set the identification information,

in which the presentation information generation unit judges whether the identification information of the delivery data received by the reception unit matches the identification information set by the setting unit and generates, when the identification information items match, information for presenting the delivery data body corresponding to the identification information.

(9) The reception apparatus according to (8),

in which the setting unit generates a screen on which at least one delivery subject can be selected out of a plurality of delivery subjects corresponding to the plurality of identification information items, and

in which the presentation information generation unit generates image information of the delivery subject corresponding to the at least one identification information item selected by the user.

(10) The reception apparatus according to (8),

in which the presentation information generation unit generates audio information of the delivery data body corresponding to the at least one identification information item selected by the user.

(11) A broadcast system, including:

a transmission apparatus including

a generation unit configured to generate, in broadcast data, in association with a delivery data body, posting time information of the delivery data body, and identification information for identifying a delivery subject of the delivery data body, delivery data including the delivery data body, the posting time information, and the identification information, and

a transmission unit configured to transmit the broadcast data including the generated delivery data; and

a reception apparatus including
a reception unit capable of receiving the delivery data included in the transmitted broadcast data, and
a presentation information generation unit configured to generate, based on the received identification information of the delivery data, information for presenting the delivery data body corresponding to the identification information in a time series based on the posting time information.

(12) A transmission method, including:

generating, in broadcast data, in association with a delivery data body, posting time information of the delivery data body, and identification information for identifying a delivery subject of the delivery data body, delivery data including the delivery data body, the posting time information, and the identification information; and

transmitting the broadcast data including the generated delivery data such that, based on the identification information of the delivery data, a reception apparatus can receive the delivery data body corresponding to the identification information.

(13) A reception method, including:

receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and

generating, based on the received identification information of the delivery data, information for presenting the delivery data body corresponding to the identification information in a time series based on the posting time information.

(14) A program that causes a computer to execute the steps of:

generating, in broadcast data, in association with a delivery data body, posting time information of the delivery data body, and identification information for identifying a delivery subject of the delivery data body, delivery data including the delivery data body, the posting time information, and the identification information; and

transmitting the broadcast data including the generated delivery data such that, based on the identification information of the delivery data, a reception apparatus can receive the delivery data body corresponding to the identification information.

(15) A program that causes a computer to execute the steps of:

receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and

generating, based on the received identification information of the delivery data, information for presenting the delivery data body corresponding to the identification information in a time series based on the posting time information.

The present disclosure contains subject matter related to that disclosed in Japanese Priority Patent Application JP 2011-134938 filed in the Japan Patent Office on Jun. 17, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A transmission apparatus, comprising:
a generation unit configured to generate, in broadcast data, in association with a delivery data body, posting time information of the delivery data body, and identification information for identifying a delivery subject of the delivery data body, delivery data including the delivery data body, the posting time information, and the identification information; and
a transmission unit configured to transmit the broadcast data including the generated delivery data such that, based on the identification information of the delivery data, a reception apparatus can receive the delivery data body corresponding to the identification information.

2. The transmission apparatus according to claim 1,
wherein the generation unit generates the delivery data in subtitle data out of the broadcast data.

3. The transmission apparatus according to claim 2,
wherein the generation unit generates the delivery data in at least one of a subtitle management data packet and a subtitle sentence data packet in the subtitle data.

4. The transmission apparatus according to claim 1,
wherein the generation unit additionally generates, in the broadcast data, one service name information item associated with a plurality of different identification information items.

5. The transmission apparatus according to claim 1,
wherein the generation unit additionally generates, in the broadcast data, information indicating which of official identification information and unofficial identification information the identification information is.

6. The transmission apparatus according to claim 1, further comprising:
an extraction unit configured to extract, from a server capable of storing a posting data body, posting time information of the posting data body, and identification information for identifying a posting subject of the posting data body in association with one another, the posting data body, the posting time information, and the identification information of the posting subject; and
a conversion unit configured to convert the posting data body, the posting time information, and the identification information of the posting subject that have been extracted into the delivery data body, the posting time information, and the identification information.

7. A reception apparatus, comprising:
a reception unit capable of receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and
a presentation information generation unit configured to generate, based on the received identification information of the delivery data, information for presenting the delivery data body corresponding to the identification information in a time series based on the posting time information.

8. The reception apparatus according to claim 7, further comprising
a setting unit configured to prompt a user of the reception apparatus to select at least one identification information item out of a plurality of different identification information items and set the identification information,
wherein the presentation information generation unit judges whether the identification information of the delivery data received by the reception unit matches the identification information set by the setting unit and generates, when the identification information items match, information for presenting the delivery data body corresponding to the identification information.

9. The reception apparatus according to claim 8,
wherein the setting unit generates a screen on which at least one delivery subject can be selected out of a plurality of delivery subjects corresponding to the plurality of identification information items, and
wherein the presentation information generation unit generates image information of the delivery subject corresponding to the at least one identification information item selected by the user.

10. The reception apparatus according to claim 8,
wherein the presentation information generation unit generates audio information of the delivery data body corresponding to the at least one identification information item selected by the user.

11. A broadcast system, comprising:
a transmission apparatus including
a generation unit configured to generate, in broadcast data, in association with a delivery data body, posting time information of the delivery data body, and identification information for identifying a delivery subject of the delivery data body, delivery data including the delivery data body, the posting time information, and the identification information, and
a transmission unit configured to transmit the broadcast data including the generated delivery data; and
a reception apparatus including
a reception unit capable of receiving the delivery data included in the transmitted broadcast data, and
a presentation information generation unit configured to generate, based on the received identification information of the delivery data, information for presenting the delivery data body corresponding to the identification information in a time series based on the posting time information.

12. A transmission method, comprising:
generating, in broadcast data, in association with a delivery data body, posting time information of the delivery data body, and identification information for identifying a delivery subject of the delivery data body, delivery data including the delivery data body, the posting time information, and the identification information; and
transmitting the broadcast data including the generated delivery data such that, based on the identification information of the delivery data, a reception apparatus can receive the delivery data body corresponding to the identification information.

13. A reception method, comprising:
receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and
generating, based on the received identification information of the delivery data, information for presenting the delivery data body corresponding to the identification information in a time series based on the posting time information.

14. A program that causes a computer to execute the steps of:
generating, in broadcast data, in association with a delivery data body, posting time information of the delivery data body, and identification information for identifying a delivery subject of the delivery data body, delivery data including the delivery data body, the posting time information, and the identification information; and
transmitting the broadcast data including the generated delivery data such that, based on the identification information of the delivery data, a reception apparatus can receive the delivery data body corresponding to the identification information.

15. A program that causes a computer to execute the steps of:
receiving delivery data that is included in broadcast data transmitted from a transmission apparatus by broadcast, the delivery data including a delivery data body, posting time information of the delivery data body, and identification information for identifying a delivery subject of the delivery data body that are associated with one another; and
generating, based on the received identification information of the delivery data, information for presenting the delivery data body corresponding to the identification information in a time series based on the posting time information.
